(19) United States
(12) Patent Application Publication
(10) Pub. No.: US 2024/0424323 A1
(43) Pub. Date: Dec. 26, 2024

(54) ROPE CLAMPING DEVICE AND METHOD OF USE

(71) Applicant: ZEDEL, Crolles (FR)

(72) Inventors: Pierre-Olivier CHABOD, Pontcharra (FR); Christophe QUILLARD, Eybens (FR)

(73) Assignee: ZEDEL, Crolles (FR)

(21) Appl. No.: 18/746,346

(22) Filed: Jun. 18, 2024

(30) Foreign Application Priority Data
Jun. 21, 2023 (FR) 2306396

(51) Int. Cl. A62B 1/14; F16D 63/00

(52) U.S. Cl. CPC A62B 1/14; F16D 63/008

(57) ABSTRACT

A rope clamping device comprises a body with a stop and a swivelling cam. A first spring has two ends functionally connected respectively to the cam and to the body by a first mechanical connection and a second mechanical connection. When the selector switch is in an actuation position, the first spring opposes movement of the cam away from the stop. When the selector switch is in an unlocked position, the first spring does not oppose movement of the cam away from the stop or opposes movement of the cam towards the stop. In the unlocked position, the selector switch eliminates one of the first and second mechanical connections or inverts the two mechanical connections.

### BACKGROUND OF THE INVENTION

The invention relates to a rope clamping device and to a method for using a rope clamping device.

### STATE OF THE ART

In mountain climbing and other mountaineering activities, it is commonplace to have a belay device inside which a rope runs attaching the climber to the belay device. Belay devices have to address two distinct issues. The belay device must be easy to use, i.e. it must be easy to make the rope run in the belay device to provide the climber with rope, or on the contrary it must be easy to take rope up quickly. A rope running path presenting low friction is therefore required.

It is also necessary for the belay device to be safety-oriented proposing adjustable braking of the rope when the climber performs a descent and/or to present assisted clamping. It is also important for the belay device to procure efficient clamping of the rope and preferably clamping in response to sliding of the rope representative of a fall. It is also advantageous for the belay device to be tolerant to mishandling and above all for it not to be too complex to handle.

Cam-assisted belay devices exist having a movable cam that is able to swivel. The cam swivels between a first position where the rope is clamped between the cam and a clamping zone and a second position where the distance between the cam and the clamping zone is greater than the diameter of the rope, thereby allowing the rope to slide. The rope runs inside the belay device and slides along the cam resulting in friction. The shape of the cam and the shape of the rope running path in the belay device define the intensity of friction of the rope. To provide the climber with rope, it is necessary to acquire a certain dexterity to avoid making the cam rotate thereby blocking sliding of the rope. The friction intensity changes depending on the diameter and the degree of wear of the rope. The applicant markets a device of this kind under the tradename GRIGRI®.

The two above-mentioned technical requirements are rather contradictory due to the fact that, to provide adjustable braking or assisted rope clamping, it is necessary to have a part in continuous contact with the rope and with sufficient friction to detect the running conditions of the rope in the belay device, and the friction has to be reduced when the climber is provided with rope. A trade-off therefore has to be made between safety and practicality of use when manufacturing the belay device.

This trade-off is all the more difficult to find as the belay device also has to be used for top rope belaying, i.e. the climber is belayed by means of a rope that passes via the top of the climbing route. As the climber progressively ascends on the route, rope is taken up, whereas the opposite operation is performed for a lead climber. It is therefore sought to have a movement of the rope that does not result in systemic clamping of the rope.

### SUMMARY OF THE INVENTION

One object of the invention consists in providing a rope clamping device equipped with a movable cam that presents workings that are better suited to the different climbing phases depending on whether the climber is the lead climber or in top rope position.

These shortcomings tend to be resolved by means of a rope clamping device comprising:
a body having a stop;
a first pivot shaft fixed to the body;
a locking cam installed swivelling around the first pivot shaft, the locking cam being installed movable with respect to the stop between a first position and a second position, the second position being farther from the stop than the first position;
a first spring having a first end and a second end, one of the first end and the second end being functionally connected to the locking cam by a first support and the other of the first end and the second end being functionally connected to the body by a second support;
a handle fitted movable with respect to the body and fixed to the locking cam to make the locking cam swivel.

The clamping device is remarkable in that a selector switch is fixed to the body and is installed movable with respect to the body between an unlocked position and an actuation position.

When the selector switch is in the actuation position, the first spring opposes swivelling of the locking cam in a direction corresponding to movement of the locking cam away from the stop.

When the selector switch is in the unlocked position, the first spring does not oppose swivelling of the locking cam in a direction corresponding to movement of the locking cam away from the stop or opposes swivelling of the locking cam in a direction corresponding to movement of the locking cam towards the stop.

In the unlocked position, the selector switch eliminates one of the first support and the second support or inverts the first support and the second support.

According to one feature of the invention, when the selector switch is in the unlocked position and the locking cam is in the second position, the locking cam is not functionally connected to the first spring so that the locking cam can move independently from the first spring.

In preferential manner, the selector switch has an obstacle jamming the second end of the first spring at a distance from the locking cam.

Advantageously, when the locking cam is in the first position, the second end of the first spring prevents movement of the selector switch from the actuation position to the unlocked position.

In a particular embodiment, when the locking cam is in the second position, the second end of the first spring prevents movement of the selector switch from the actuation position to the unlocked position.

Preferentially, when the locking cam is in a third position, the second end of the first spring allows movement of the selector switch from the actuation position to the unlocked position, the third position being farther from the stop than the second position.

In advantageous manner, when the locking cam is in the first position, the second end of the first spring prevents movement of the selector switch from the unlocked position to the actuation position and/or when the locking cam is in the second position, the second end of the first spring prevents movement of the selector switch from the unlocked position to the actuation position.

In a particular embodiment, the clamping device comprises a control device installed movable between a clamping position and a release position. In the clamping position, the control device blocks the selector switch in the actuation position.

According to another feature, the first spring is a torsion spring passed through by the first pivot shaft.

Preferentially, the selector switch is installed swivelling around the first pivot shaft. In the actuation position, a pin of the selector switch is arranged pressing against the first end of the first spring at a distance from the second end of the first spring. In the locked position, the pin of the selector switch is arranged pressing against the second end of the first spring at a distance from the first end of the first spring.

In preferential manner, when the selector switch is in the actuation position and the locking cam is in the first position, the first end and the second end define an angle of less than 90° and the pin of the selector switch is located between the first end and the second end, in the surface defined by the angle.

In preferential manner, the clamping device comprises a second spring having a first end fixed to the locking cam and a second end fixed to the body, the second spring applying a force opposing swivelling of the first spring from the third position to the first position, the second spring having a lower stiffness than the stiffness of the first spring.

It is a further object of the invention to provide a method for using a clamping device that improves management of the movements of the rope inside the clamping device depending on whether the climber is lead climber or in top rope position.

This result tends to be achieved by means of a method for using a rope clamping device comprising the following steps:
providing a clamping device according to any one of the foregoing configurations;
inserting a rope in the clamping device;
moving a selector switch between an unlocked position and an actuation position.

### DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 illustrates a schematic perspective view of a first embodiment of a rope clamping device with a selector switch in the actuation position;

FIG. 2 illustrates a schematic perspective view of a first embodiment of an open rope clamping device for insertion of a rope between two flanges;

FIG. 3 illustrates an exploded view of a first embodiment of a rope clamping device;

FIG. 4 illustrates a schematic elevational view of a first embodiment of a rope clamping device with a selector switch in the actuation position;

FIG. 5 illustrates a schematic cross-sectional view, inside a cover, of a first embodiment of a rope clamping device with a selector switch in the actuation position;

FIG. 6 illustrates a schematic elevational view of a first embodiment of a rope clamping device with a selector switch in the actuation position and the locking cam in the third position;

FIG. 7 illustrates a schematic cross-sectional view, inside a cover, of a first embodiment of a rope clamping device with a selector switch in the actuation position and the locking cam in the third position;

FIG. 8 illustrates a schematic elevational view of a first embodiment of a rope clamping device with a selector switch in the unlocked position and the locking cam in the third position;

FIG. 9 illustrates a schematic cross-sectional view, inside a cover, of a first embodiment of a rope clamping device with a selector switch in the unlocked position and the locking cam in the third position;

FIG. 10 illustrates a schematic elevational view of a first embodiment of a rope clamping device with a selector switch in the unlocked position and the locking cam in the second position;

FIG. 11 illustrates a schematic cross-sectional view, inside a cover, of a first embodiment of a rope clamping device with a selector switch in the unlocked position and the locking cam in the second position;

FIG. 12 illustrates an exploded view of a second embodiment of a rope clamping device;

FIG. 13 illustrates a schematic elevational view of a second embodiment of a rope clamping device with a selector switch in the actuation position;

FIG. 14 illustrates a schematic cross-sectional view, inside a cover, of a second embodiment of a rope clamping device with a selector switch in the actuation position;

FIG. 15 illustrates a schematic elevational view of a second embodiment of a rope clamping device with a selector switch in the actuation position and the locking cam in the third position;

FIG. 16 illustrates a schematic cross-sectional view, inside a cover, of a second embodiment of a rope clamping device with a selector switch in the actuation position and the locking cam in the third position;

FIG. 17 illustrates a schematic elevational view of a second embodiment of a rope clamping device with a selector switch in the unlocked position and the locking cam in the third position;

FIG. 18 illustrates a schematic cross-sectional view, inside a cover, of a second embodiment of a rope clamping device with a selector switch in the unlocked position and the locking cam in the third position;

FIG. 19 illustrates a schematic elevational view of a second embodiment of a rope clamping device with a selector switch in the unlocked position and the locking cam in the second position;

FIG. 20 illustrates a schematic cross-sectional view, inside a cover, of a second embodiment of a rope clamping device with a selector switch in the unlocked position and the locking cam in the second position;

FIG. 21 illustrates an exploded view of a third embodiment of a rope clamping device;

FIG. 22 illustrates a schematic elevational view of a third embodiment of a rope clamping device with a selector switch in the actuation position and a movable control device in the clamping position;

FIG. 23 illustrates a schematic cross-sectional view, inside a cover, of a third embodiment of a rope clamping device with a selector switch in the actuation position and a movable control device in the clamping position;

FIG. 24 illustrates a schematic elevational view of a third embodiment of a rope clamping device with a selector switch in the actuation position and a movable control device in the release position;

FIG. 25 illustrates a schematic cross-sectional view, inside a cover, of a third embodiment of a rope clamping device with a selector switch in the actuation position and a movable control device in the release position;

FIG. 26 illustrates a schematic elevational view of a third embodiment of a rope clamping device with a selector switch in the actuation position, the locking cam in the third position and a movable control device in the release position;

FIG. 27 illustrates a schematic cross-sectional view, inside a cover, of a third embodiment of a rope clamping device with a selector switch in the actuation position, the locking cam in the third position and a movable control device in the release position;

FIG. 28 illustrates a schematic elevational view of a third embodiment of a rope clamping device with a selector switch in the unlocked position, the locking cam in the third position and a movable control device in the release position;

FIG. 29 illustrates a schematic cross-sectional view, inside a cover, of a third embodiment of a rope clamping device with a selector switch in the unlocked position, the locking cam in the third position and a movable control device in the release position;

FIG. 30 illustrates a schematic elevational view of a third embodiment of a rope clamping device with a selector switch in the release position, the locking cam in the second position and a movable control device in the release position;

FIG. 31 illustrates a schematic cross-sectional view, inside a cover, of a third embodiment of a rope clamping device with a selector switch in the unlocked position, the locking cam in the second position and a movable control device in the release position;

FIG. 32 illustrates a schematic elevational view of a third embodiment of a rope clamping device with a selector switch in the unlocked position, the locking cam in the second position and a movable control device in the clamping position;

FIG. 33 illustrates a schematic cross-sectional view, inside a cover, of a third embodiment of a rope clamping device with a selector switch in the unlocked position and the locking cam in the second position and a movable control device in the clamping position;

FIG. 34 illustrates an exploded view of a fourth embodiment of a rope clamping device;

FIG. 35 illustrates a schematic elevational view of a fourth embodiment of a rope clamping device with a selector switch in the actuation position;

FIG. 36 illustrates a schematic cross-sectional view, inside a cover, of a fourth embodiment of a rope clamping device with a selector switch in the actuation position;

FIG. 37 illustrates a schematic elevational view of a fourth embodiment of a rope clamping device with a selector switch between the actuation position and the unlocked position;

FIG. 38 illustrates a schematic cross-sectional view, inside a cover, of a fourth embodiment of a rope clamping device with a selector switch between the actuation position and the unlocked position;

FIG. 39 illustrates a schematic elevational view of a fourth embodiment of a rope clamping device with a selector switch in the unlocked position and the locking cam in the third position;

FIG. 40 illustrates a schematic cross-sectional view, inside a cover, of a fourth embodiment of a rope clamping device with a selector switch in the unlocked position and the locking cam in the third position.

### DETAILED DESCRIPTION

The rope clamping device comprises a body 1 provided with a stop 2. The stop 2 forms a clamping zone where a strand of a rope A is designed to be clamped. The rope clamping device comprises a first pivot shaft 3 that is fixed to the body 1, preferably that is installed fixedly on the body 1. The body 1 defines a path designed to receive a strand of rope.

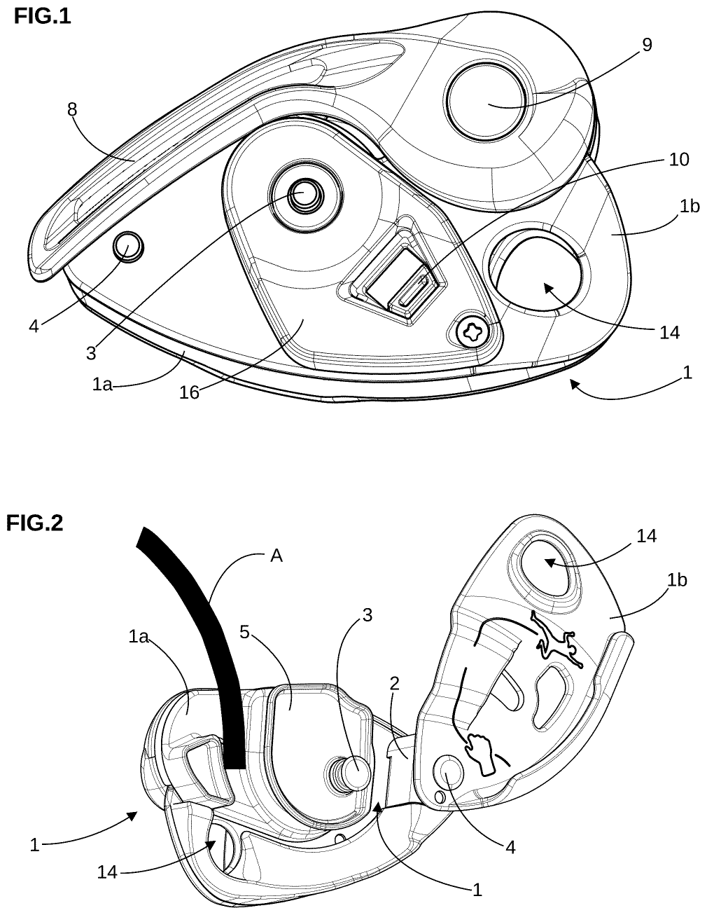

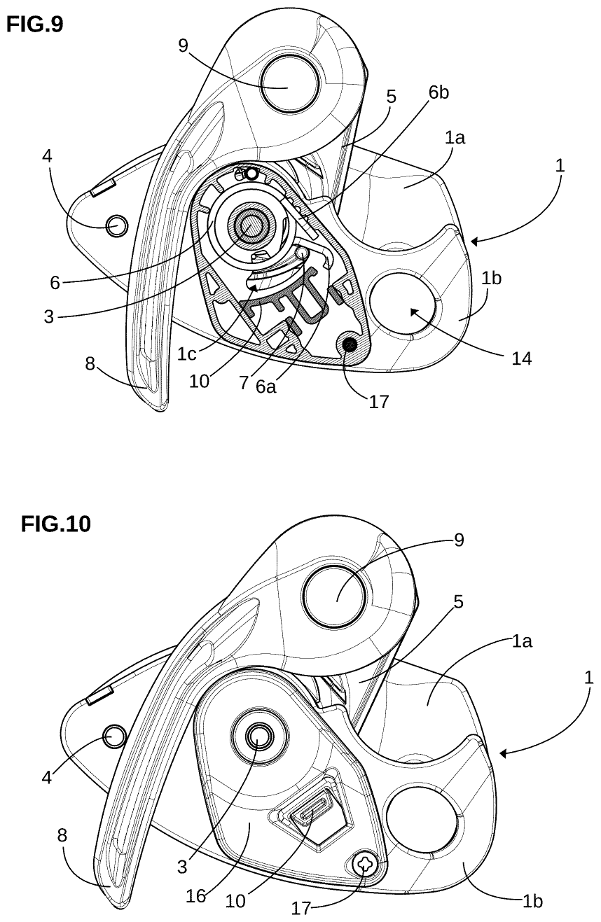

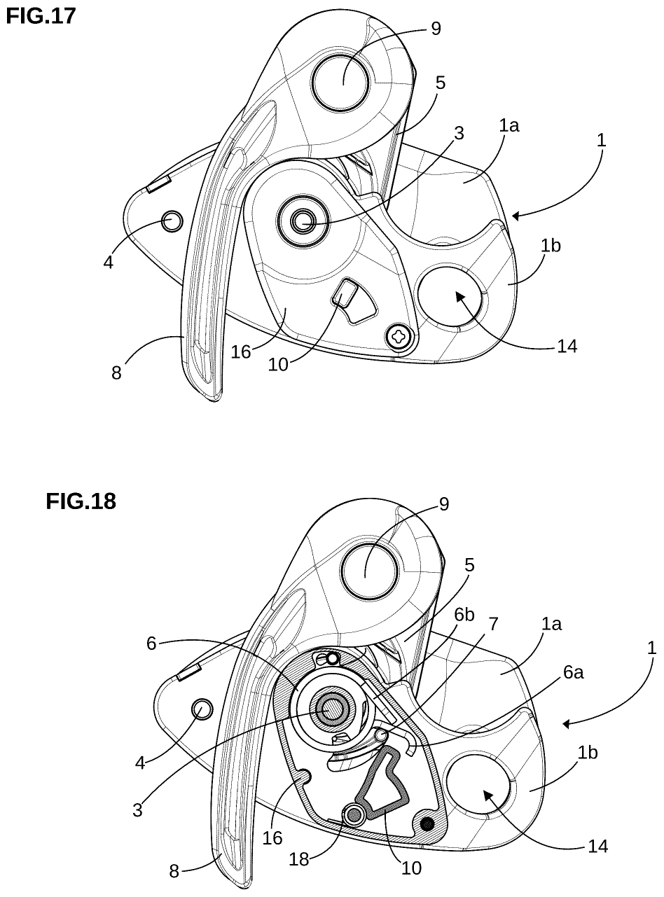

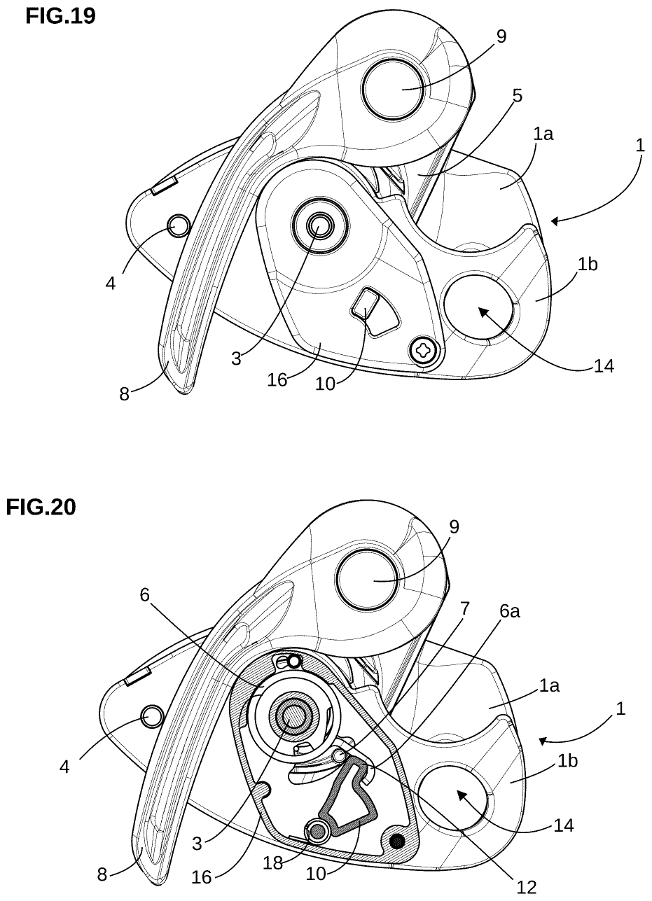

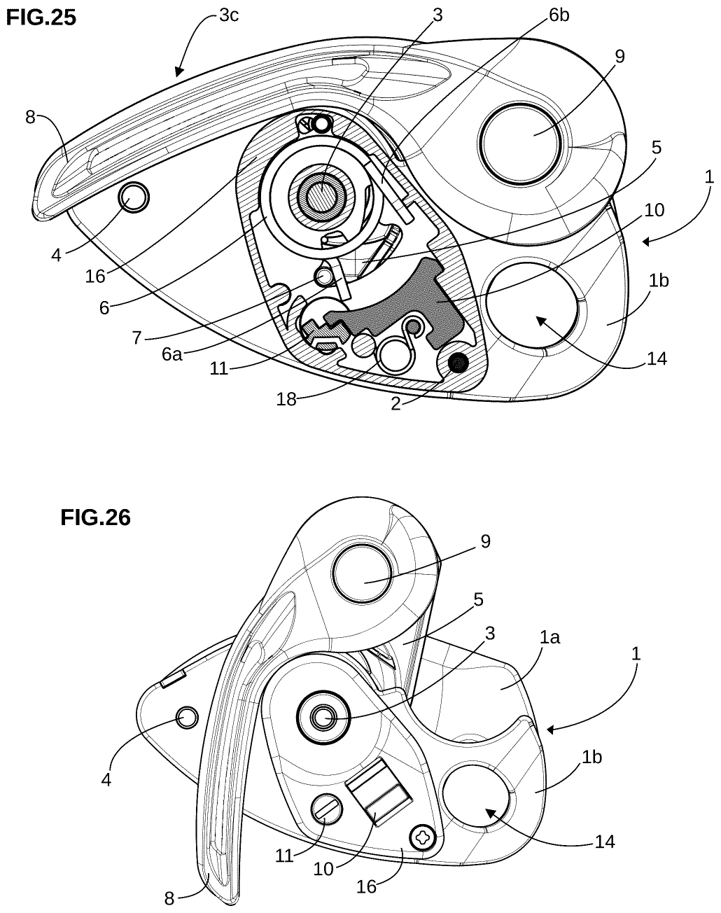

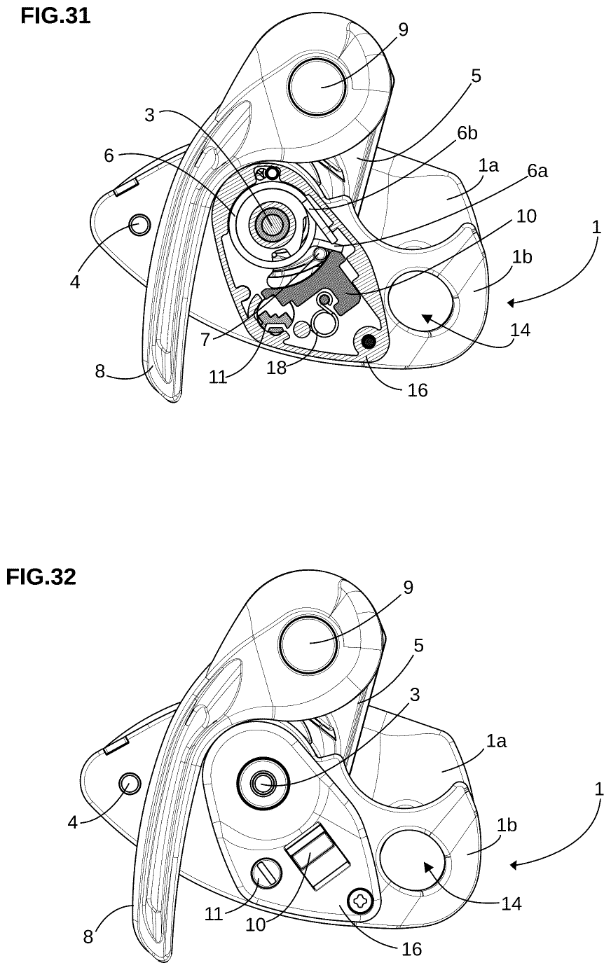

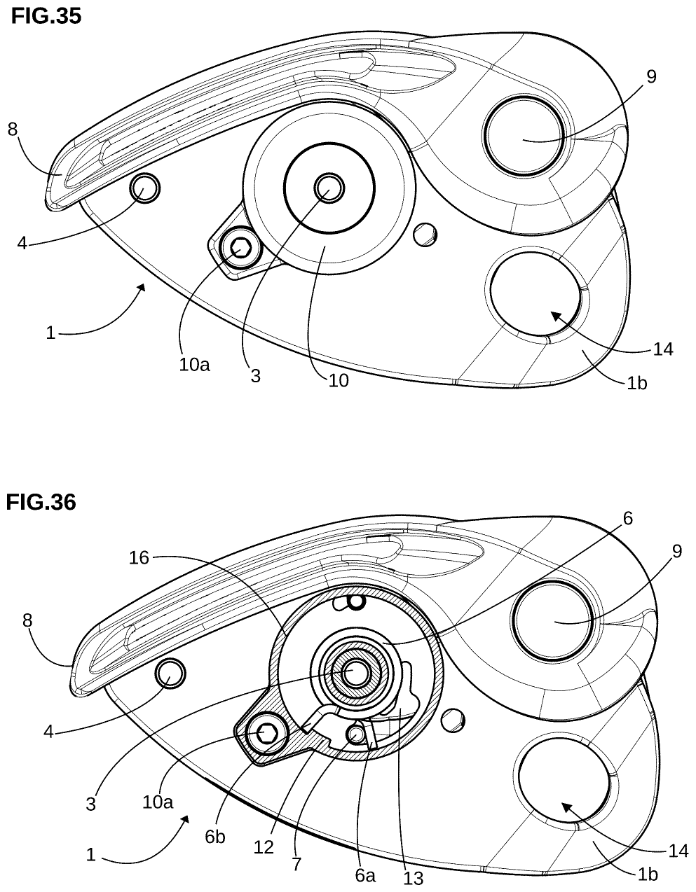

In a particular embodiment, the body 1 has a first flange 1a and a second flange 1b that is installed movable or removable with respect to the first flange 1a. FIGS. 1, 4 to 11, 13 to 20, 22 to 33 and 35 to 40 illustrate a closed body, i.e. with the two flanges delineating a cavity designed to receive a strand of the rope A. FIG. 2 illustrates an open body with the second flange 1b offset with respect to the first flange 1a. In the illustrated embodiments, the second flange 1b is installed swivelling with respect to the first flange 1a. The second flange 1b is installed swivelling around a body pivot shaft 4 fixed to the first flange 1a. In an alternative embodiment, the second flange 1b can be installed swivelling around the first pivot shaft 3.

The rope clamping device comprises a locking cam 5 installed swivelling around the first pivot shaft 3. The locking cam 5 is installed movable with respect to the stop 2 between a first position, a second position and a third position. The third position of the locking cam 5 is farther from the stop 2 than the second position that is farther from the stop 2 than the first position. The second position is located between the first position and the third position. The first position is designed to clamp the strand of the rope A that runs in the path inside the body 1. The locking cam 5 swivels inside the body 1 to move away from or towards the stop 2. In the second and third positions, the locking cam 5 is designed to allow the rope A to slide inside the body 1. The running path passes round the locking cam 5, and a part of the side wall of the path is formed by the locking cam 5 so that sliding of the rope A in the body 1 applies a force on the locking cam 5 inciting the locking cam 5 to swivel in a first direction or in a second direction.

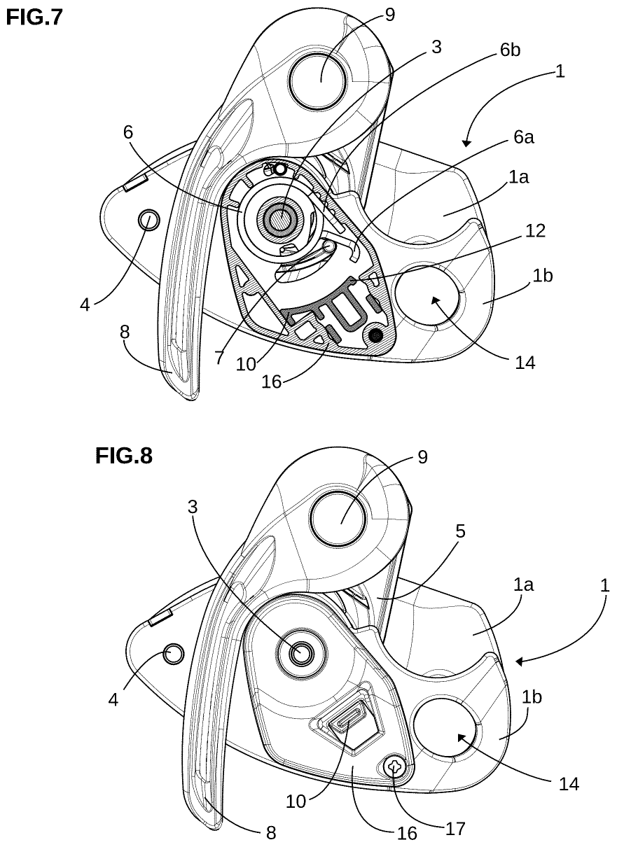

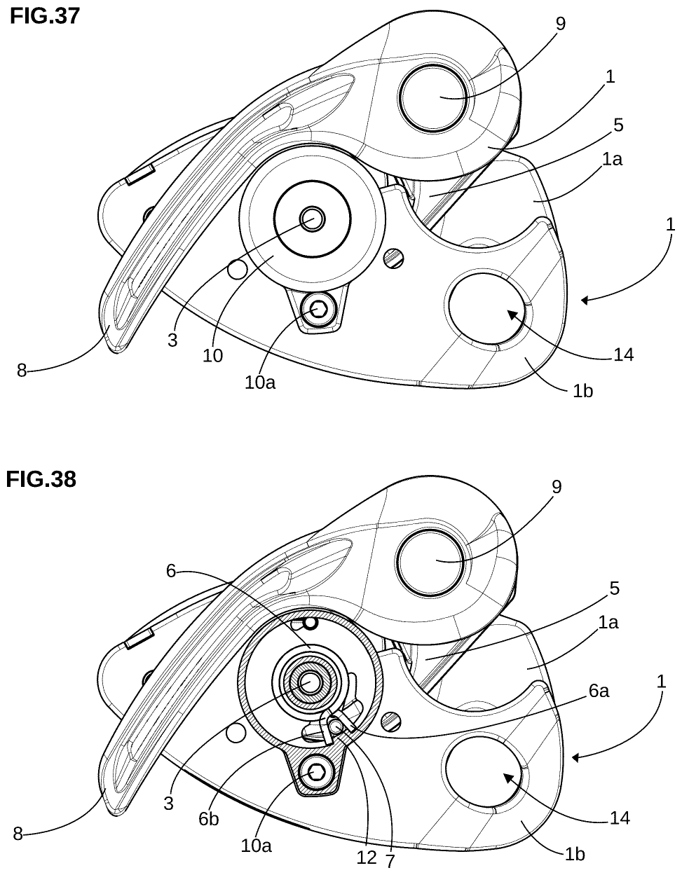

FIGS. 4, 5, 13, 14, 22, 23, 24, 25, 35 and 36 illustrate the locking cam 5 in the first position. FIGS. 37 and 38 illustrate the locking cam 5 in the second position. FIGS. 7, 8, 9, 10, 11, 15, 16, 17, 18, 19, 20, 26, 27, 28, 29, 30, 31, 32, 33, 39 and 40 illustrate the locking cam 5 in the third position.

The clamping device comprises a first spring 6 having a first end 6a and a second end 6b. One of the first end 6a and the second end 6b is functionally connected to the locking cam 5 by a first mechanical connection, for example the first end 6a is pressing on or attached to the locking cam 5. The other of the first end 6a and the second end 6b is functionally connected to the body 1 by a second mechanical connection, for example the second end 6b is pressing on or attached to the body 1. The first spring 6 is mechanically connected to the body 1 and to the locking cam 5. In one operating mode, swivelling of the locking cam 5 with respect to the body 1 causes deformation of the first spring 6. If no external stress is applied, the first spring 6 is biased to reach its least stressed state and moves the locking cam 5 to the first position. In other words, swivelling the locking cam 5 loads the first spring 6. Each position of the locking cam 5 corresponds to a particular deformation of the first spring 6. The further the locking cam 5 is from the stop 2, the greater the deformation of the first spring 6, i.e. the further the stress on the first spring 6 is from the state of minimum stress.

The first spring 6 is mechanically stressed between the first end 6a and the second end 6b. Rotation of the locking cam 5 applies a force on the first spring 6. The first spring 6 applies an opposite force that tends to bias the locking cam 5 to the first position.

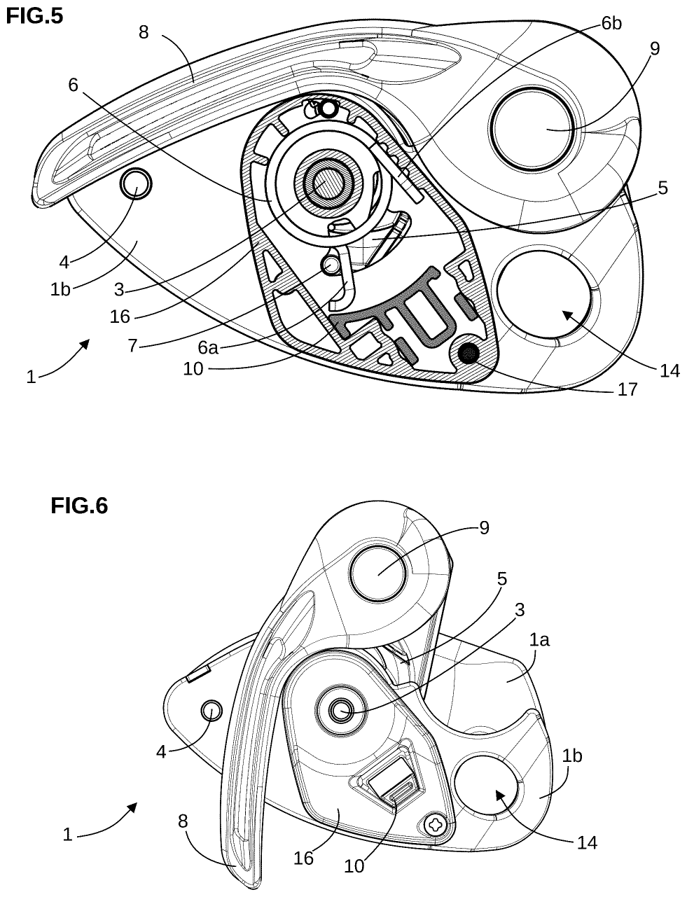

In an advantageous embodiment, the first spring 6 and the locking cam 5 are separated by a part of the body 1, for example by one of the first flange 1a and the second flange 1b. The body 1 defines an aperture 1c, and a pin 7 of the locking cam 5 passes through the aperture 1c. The pin 7 moves along the aperture 1c between the first position and the third position. Preferentially, the pin 7 is pressing on one end of the aperture 1c when the locking cam 5 is in the first position as illustrated in FIGS. 5, 14, 23, 25 and 36. Preferentially, if no external stress is applied, the first spring 6 applies a force that presses the pin 7 against one end of the aperture 1c. As an alternative, one end of the first spring 6 passes through the aperture 1c and is pressing against a side wall of a hole of the locking cam 5. When the locking cam 5 leaves the first position, the side wall presses on the end of the first spring 6. In another alternative, the first spring 6 and the locking cam 5 are on the same side of the flange.

A handle 8 is fixed to the locking cam 5, preferably at a distance from the pivot axis of the locking cam 5 with respect to the body 1. The handle 8 is installed movable with respect to the body 1 to follow swivelling of the locking cam 5. Preferentially, the handle 8 is fixed to the locking cam 5 by means of a second pivot shaft 9. The second pivot shaft 9 is stationary with respect to the locking cam 5 so as to swivel around the first pivot shaft 3. The handle 8 can be installed movable between a stowing position and an actuation position in a manner that is known as such. Switching from the stowing position to the actuation position is achieved by swivelling the handle 8 in a first direction. In the different figures, only the stowing position is illustrated. In the actuation position, the handle 8 is pressing against the stop formed by the locking cam 5 so that rotation of the handle 8 in the first direction cause rotation of the locking cam 5 in the direction of the first position, i.e. in a direction moving the stop 2 and the locking cam 5 towards one another.

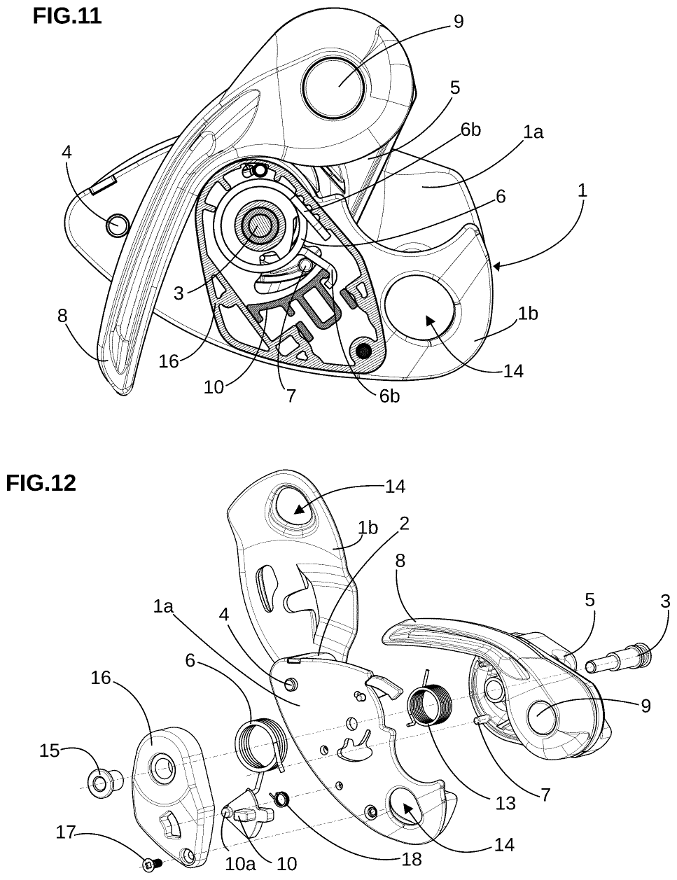

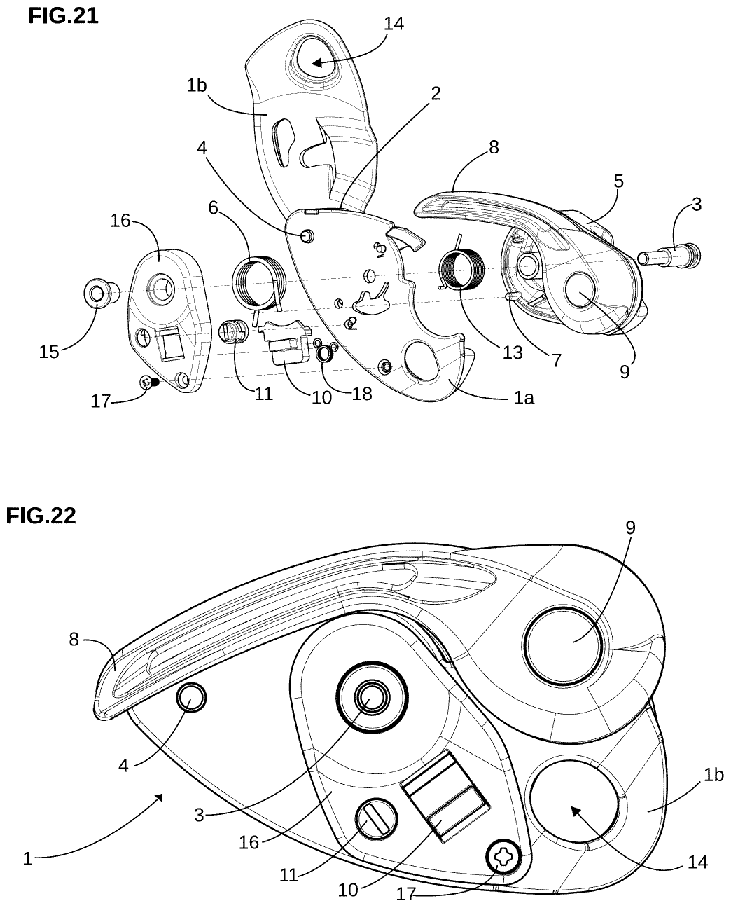

The rope clamping device also comprises a selector switch 10 that is fixed to the body 1 and is movable between an unlocked position and an actuation position. The behaviour of the locking cam 5 with respect to the body 1 is different depending on whether the selector switch 10 is in the unlocked position or in the actuation position. The selector switch 10 can be installed to operate in translation or by swivelling or with any other shift mode. FIGS. 1 to 11 illustrate a selector switch 10 installed movable in translation whereas FIGS. 12 to 40 illustrate a selector switch 10 installed in swivelling manner. In the illustrated embodiments, the selector switch 10 is installed movable in a direction of movement that is perpendicular to the pivot axis of the locking cam 5 with respect to the body 1. Another direction of movement is however possible, for example along the pivot axis of the locking cam 5.

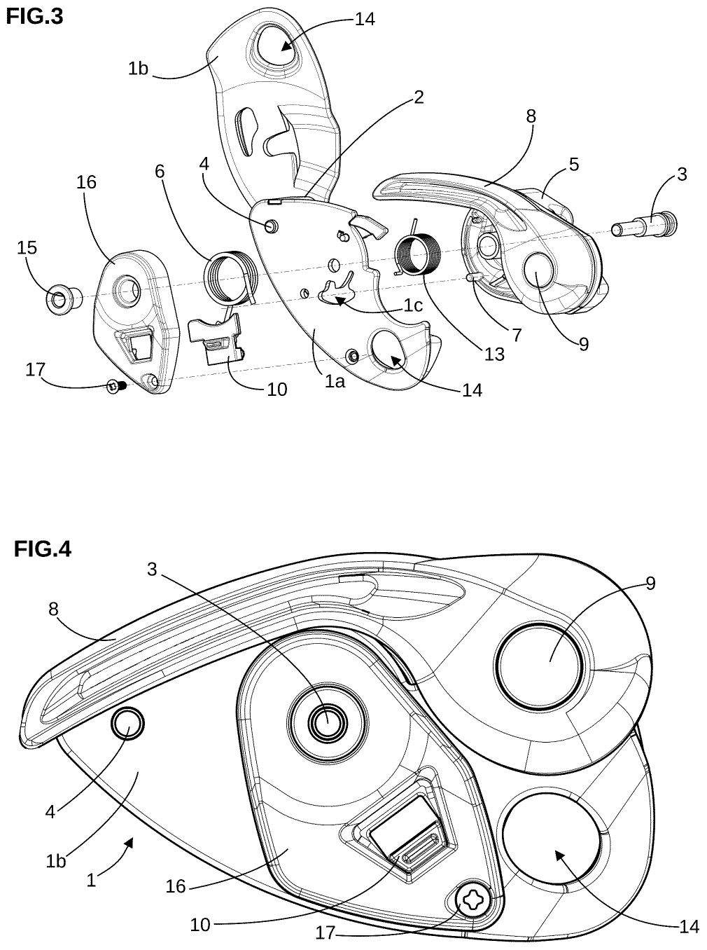

The selector switch 10 is installed movable with respect to the first spring 6 so as to modify the behaviour of the first spring 6 depending on whether the selector switch 10 is in the unlocked position or in the actuation position. In the actuation position, the first spring 6 opposes swivelling of the locking cam 5 in a direction corresponding to movement of the locking cam 5 away from the stop 2. The operation of spring 6 is identical to what is known. In the actuation position, the selector switch 10 does not modify the operation of the first spring 6 with respect to what is known. In other words, movement of the locking cam 5 modulates the deformation of the first spring 6. Preferentially, in the actuation position, the first spring 6 does not have any contact with the selector switch 10, as illustrated in the embodiments of FIGS. 3 to 33. In the unlocked position, the selector switch 10 eliminates one of the first mechanical connection and second mechanical connection, or inverts the first mechanical connection and second mechanical connection. This modifies the behaviour of the first spring 6 thereby modifying the behaviour of the locking cam 5 with respect to the movements of the rope A.

In the unlocked position, the behaviour of the first spring 6 is modified. The first spring 6 does not apply a force on the locking cam 5 opposing swivelling of the locking cam 5 in a direction corresponding to movement of the locking cam 5 away from the stop 2. In the unlocked position, the selector switch 10 does not prevent swivelling of the locking cam 5 in one direction or the other.

In an embodiment illustrated in FIGS. 3 to 33, the first spring 6 is activated when the selector switch 10 is in the actuation position, i.e. the locking cam 5 deforms the first spring 6 according to its swivelling. In the unlocked position, the selector switch 10 is designed to block the first spring 6 in a deformation state corresponding to the locking cam 5 in the third position. In preferential manner, when the selector switch 10 is in the unlocked position and the first spring 6 is jammed in a deformation state corresponding to the locking cam 5 in the third position, the selector switch 10 eliminates one of the first mechanical connection and second mechanical connection. In the illustrated embodiment, the first spring 6 is locked in a state of maximum or near-maximum deformation.

In the embodiments illustrated in FIGS. 1 to 33, in the unlocked position, the selector switch 10 eliminates the mechanical connection between the locking cam 5 and the first spring 6. In the particular embodiments illustrated in FIGS. 1 to 33, the locking cam 5 moves between the first position and the second position without being in contact with the first spring 6. Movement of the locking cam 5 does not apply any deformation on the first spring 6. In the illustrated configurations, the first end 6a is blocked in a position that corresponds to the locking cam 5 in the third position or at a distance from the positions able to be taken by the locking cam 5. FIGS. 5 to 33 illustrate an embodiment in which the first end 6a of the first spring 6 rests on the pin 7. When the first spring 6 is locked in a state of deformation corresponding to the second or third position, the movement of the locking cam 5 between the first position and the second position takes place without contact with the first spring 6, thus eliminating the mechanical connection. An identical result is obtained with the alternative described above, where the locking cam 5 defines a groove which receives the first end of the first spring 6.

In preferential manner, in the unlocked position, the selector switch 10 forms an obstacle 12 that blocks the end of the first spring 6 that collaborates with the locking cam 5 at a distance from the locking cam 5. In the embodiments illustrated in FIGS. 1 to 33, the locking cam 5 has a pin 7 that moves in an aperture of the body, and it is advantageous to block the first end of the first spring 6 at one end of the aperture or outside the aperture to allow movement of the pin 7 freely with respect to the first spring 6. In an alternative embodiment, the first end 6a of the first spring 6 passes through the body 1 to be inserted in a hole of the locking cam 5 and forms the mechanical connection. The first end of the first spring 6 presses against a side wall so as to push the locking cam 5 towards the stop 2. It is advantageous for the locking cam 5 to define a groove, and the end of the first spring 6 moves inside the groove away from the side wall without moving the locking cam 5. Clamping of the first end 6a at a distance from the side wall enables movement of the locking cam 5 to be had without any action on the first spring 6.

In an alternative embodiment, in the actuation position, the selector switch 10 forms the mechanical connection between the first spring 6 and the body 1, for example a support wall for the second end 6b of the first spring 6. In the unlocked position, the selector switch 10 interrupts the mechanical connection between the first spring 6 and the body 1. When the locking cam 5 swivels between the first position and the third position, the first spring 6 swivels without being deformed. The first spring 6 moves without applying a force opposing movement of the locking cam 5. In the release position, the switch selector 10 removes the support wall resting the second end 6b. Without the support wall, displacement of the locking cam 5 no longer causes deformation of the first spring 6 as a function of the position of the locking cam 5. Displacement of the locking cam 5 causes displacement of the first end 6a and the second end 6b. It is advantageous for the first end 6a to be fixedly mounted with the locking cam 5.

In another alternative embodiment illustrated in FIGS. 34 to 40, the selector switch 10 inverts the first mechanical connection and the second mechanical connection when it moves between the actuation position and the unlocked position. In the actuation position illustrated in FIG. 36, the selector switch 10 forms an obstacle 12 and the second end 6b of the first spring 6 is pressing against the obstacle 12. Movement of the locking cam 5 in the first swivelling direction, for example from the first position to the third position, deforms the first spring 6. For example, the movement is with a tensile force or with a movement equivalent to stretching of the spring. In the illustrated configuration, the movement of the locking cam 5 in the first swivelling direction corresponds to a movement of the first end 6a away from the second end 6b.

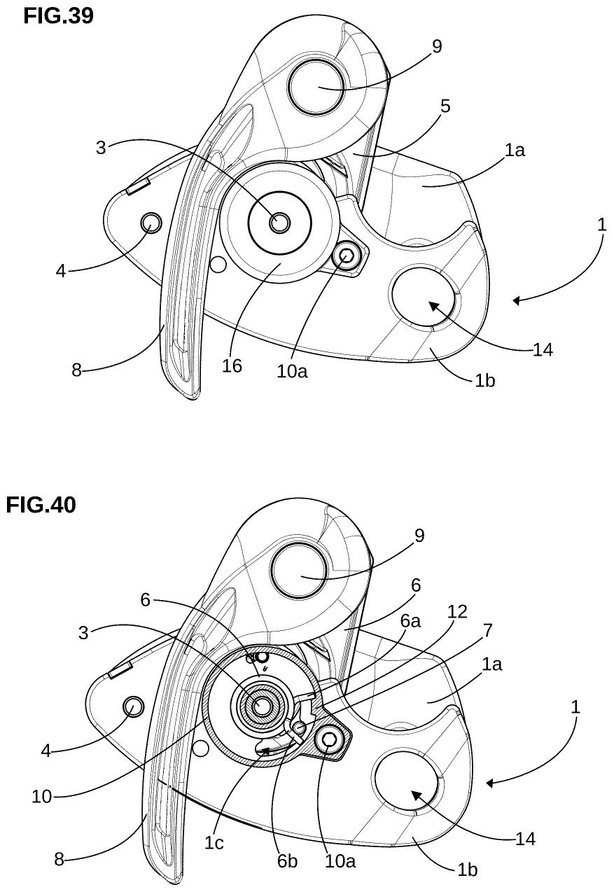

In the unlocked position illustrated in FIG. 40, the selector switch 10 forms an obstacle 12 and the first end 6a of the first spring 6 is pressing against the obstacle 12. The second end 6b is at a distance from the obstacle 12. Movement of the locking cam 5 in the second swivelling direction, for example from the third position to the first position, deforms the first spring 6. For example, the movement is with a tensile force or with a movement equivalent to stretching of the spring.

In the embodiment illustrated in FIGS. 34 to 40, the obstacle 12 moves between the first end and the second end. It is preferable for the pin 7 of the locking cam 5 to also move between the first end and the second end and for the distance accessible for the pin 7 to be less than the distance travelled by the obstacle 12 between the actuation position and the unlocked position. This enables the first spring 6 to be made to work in one direction or another depending on the position of the selector switch 10.

In a particular embodiment, in the absence of any external stress, movement of the selector switch 10 from the actuation position to the unlocked position results in swivelling of the locking cam 5 from the first position to the third position. The selector switch 10 can be kept in position with respect to the body by means of a blocker 10a that is inserted in a recess of the body to prevent rotation of the handle from resulting in movement of the locking cam 5 and of the selector switch 10. The blocker 10a can be a bolt or a rod with a resilient return device. FIG. 34 illustrates a bolt associated with a nut 10b of the prevention means. The nut and bolt enable the blocker 10a to be moved to be depressed in or extracted from the holes present in the body 1 and that enable the selector switch 10 to be blocked in one of the two positions.

In the embodiment illustrated in FIGS. 34 to 40, the pin 7 salient from the locking cam 5 and the obstacle 12 of the selector switch 10 preferentially swivel around the same pivot axis.

Activation or deactivation of the first spring 6 can be obtained in different ways to have a locking cam 5 that moves between the first position and the third position stressing or without stressing the first spring 6. In the embodiments illustrated in FIGS. 1 to 33, the first spring 6 is deactivated while being maintained in a stressed position at one end or outside the running path of the pin 7 representative of movement of the locking cam 5. An identical operation can be obtained with one end of the first spring 6 that is depressed in a groove of the locking cam 5. In an alternative embodiment, the selector switch 10 can move all or part of the first spring 6 in a direction parallel to the pivot axis of the locking cam 5 with respect to the locking cam 5 and preferentially with respect to the body 1. Movement of the first spring 6 can activate or deactivate the mechanical connection between the locking cam 5 and the first spring 6 allowing or preventing mechanical contact between one end of the first spring 6 and a portion of the locking cam 5. The same can be the case by moving the first spring 6 to form or eliminate a flexible link between the other end of the first spring 6 and the body 1.

For the sake of compactness, it is advantageous not to move all the spring so as to deactivate the first spring 6.

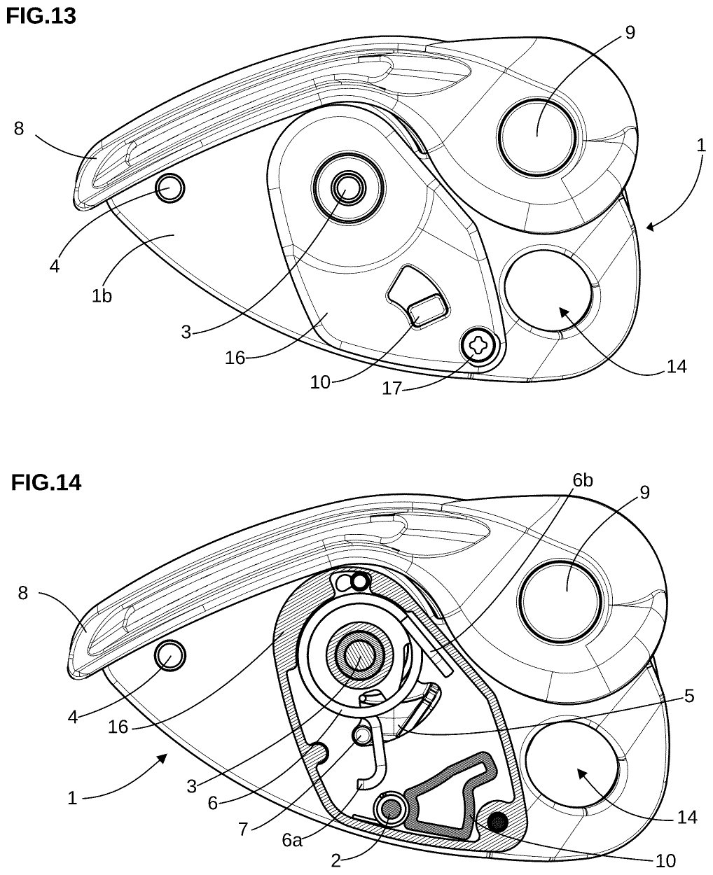

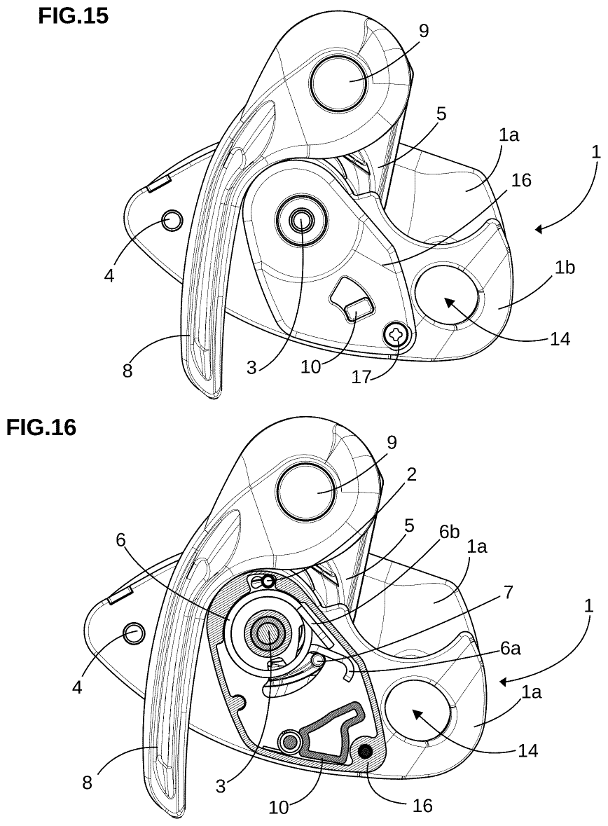

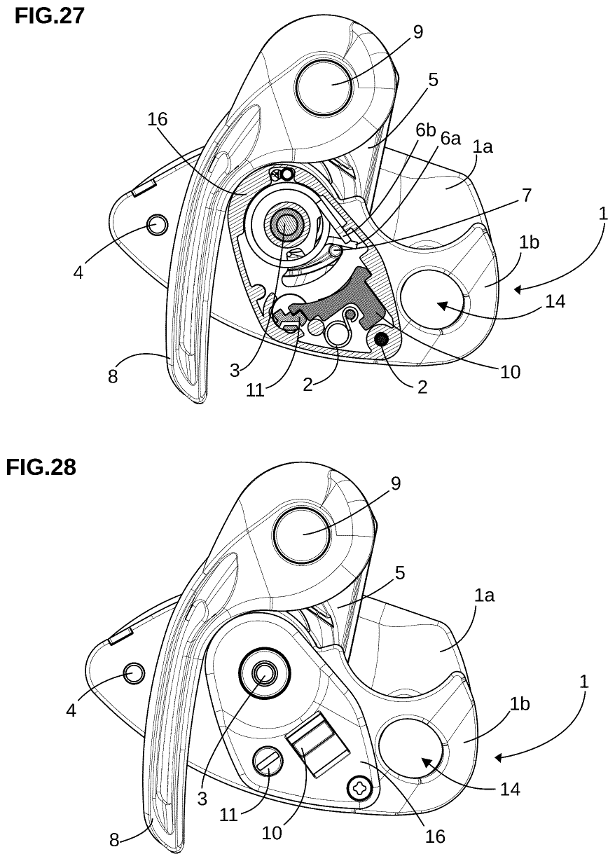

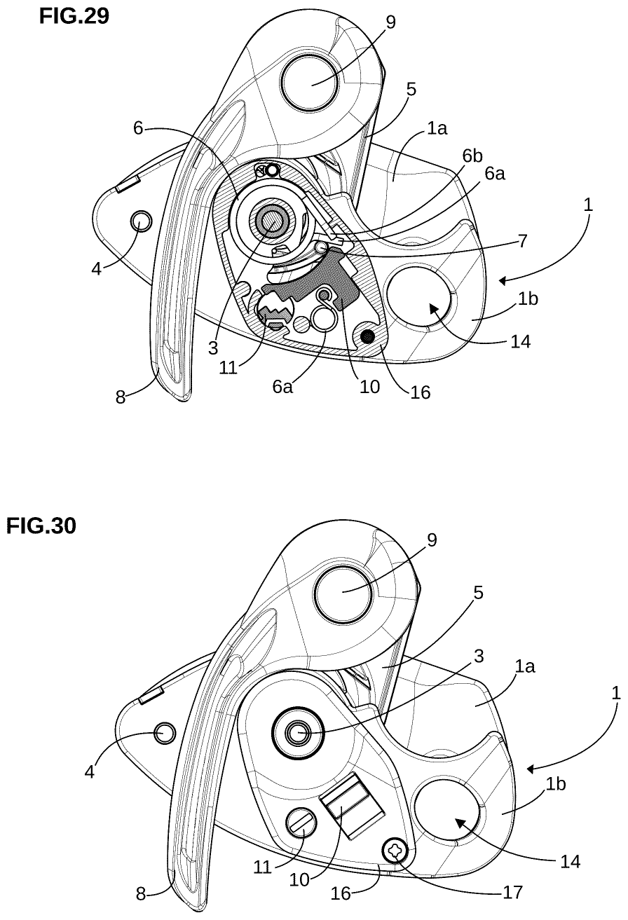

In an advantageous embodiment, the selector switch 10 can only move from the actuation position to the unlocked position when the locking cam 5 is outside the first position, preferably between the second position and the third position and more preferentially only in the third position. When the locking cam 5 is in the first position, it is advantageous for the first end 6a of the first spring 6 to prevent movement of the selector switch 10 from the actuation position to the unlocked position. This precaution prevents involuntary actuation of the selector switch 10. As the first spring 6 biases the locking cam 5 to the first position, it is necessary to act on the swivelling of the locking cam 5 prior to movement of the selector switch 10 to the unlocked position. For example, in the first position, the first end 6a of spring 6 opposes movement of the selector switch 10 to the unlocked position. It may, if applicable, be preferable for the pin 7 to oppose movement of the selector switch 10 to the unlocked position. FIGS. 4 to 11 illustrate, in side views and sectional views, a cover 16 containing the selector switch 10, swivelling of the locking cam 5 from the first position to the third position (FIGS. 4 to 7), then movement of the selector switch 10 from the actuation position to the unlocked position (FIGS. 6 to 9), then swivelling of the locking cam 5 from the third position to the second position with clamping of the first end 6a of the first spring 6 by the selector switch 10 (FIGS. 8 to 11). FIGS. 13 to 20 illustrate, in side views and sectional views, a cover 16 containing the selector switch 10, swivelling of the locking cam 5 from the first position to the third position (FIGS. 13 to 16), then movement of the selector switch 10 from the actuation position to the unlocked position (FIGS. 15 to 18), then swivelling of the locking cam 5 from the third position to the second position with clamping of the first end 6a of the first spring 6 by the selector switch 10 (FIGS. 17 to 20). FIGS. 22 to 33 illustrate side views and sectional views of a cover 16 containing the selector switch 10. FIGS. 22 to 25 illustrate movement of a control device 11 from the clamping position to the release position. FIGS. 24 to 27 illustrate swivelling of the locking cam 5 from the first position to the third position. FIGS. 26 to 29 illustrate movement of the selector switch 10 from the actuation position to the unlocked position. FIGS. 28 to 31 illustrate swivelling of the locking cam 5 from the third position to the second position with clamping of the first end 6a of the first spring 6 by the selector switch 10. FIGS. 30 to 33 illustrate movement of the control device 11 from the release position to the clamping position.

In the illustrated embodiments, the selector switch 10 is separated from the locking cam 5 by flange 1b. It is possible for the first spring 6 and at least a part of the selector switch 10 and the locking cam 5 to be on the same side of flange 1b.

In an embodiment compatible with the embodiments illustrated in FIGS. 3 to 33, the selector switch 10 can define a bevel that allows the first end 6a of the first spring 6 to slide along the bevel when the locking cam 5 moves from the first position to the third position. The bevel enables the obstacle 12 to be overcome in one direction of movement only, corresponding to the first swivelling direction. Once the locking cam 5 has reached the third position, the first end 6a can no longer move in the other direction and overcome the obstacle 12 of the selector switch 10 that is in the unlocked position. For example, the bevel can prevent movement from the actuation position to the unlocked position when the locking cam 5 is in predefined positions, for example outside the first position and the third position. As an alternative, the bevel is also inclined to allow movement from the actuation position to the unlocked position whatever the position of the locking cam 5.

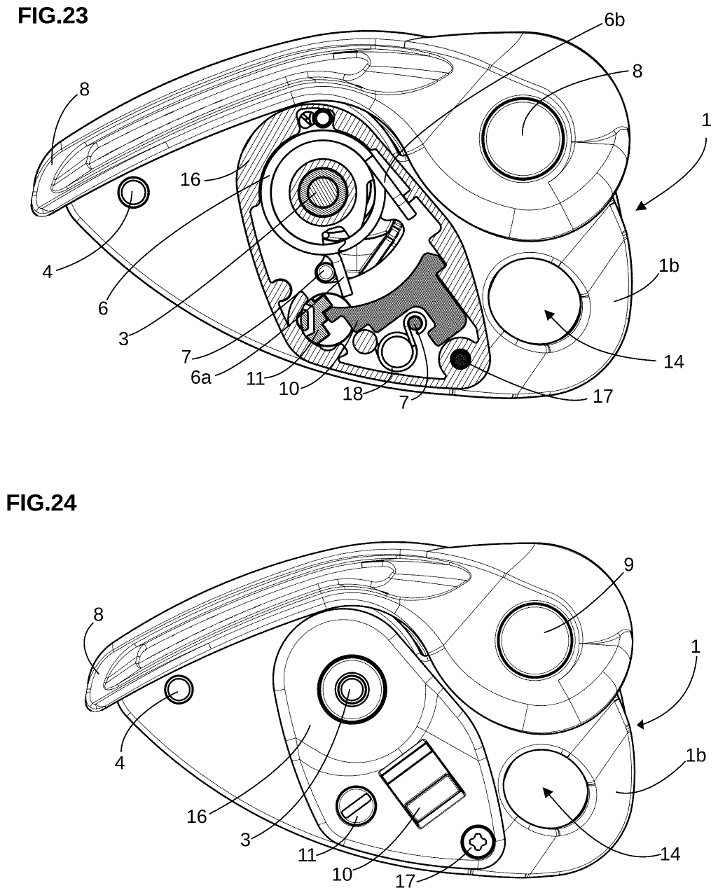

To prevent undesired movement of the selector switch 10 between the actuation position and the unlocked position in one direction or the other, it is advantageous for the clamping device to be provided with a control device 11. The control device 11 is installed movable between a clamping position and release position. It is preferable to install the control device 11 on the body 1. As illustrated in FIG. 23, in the clamping position, the control device 11 blocks the selector switch 10 in the actuation position.

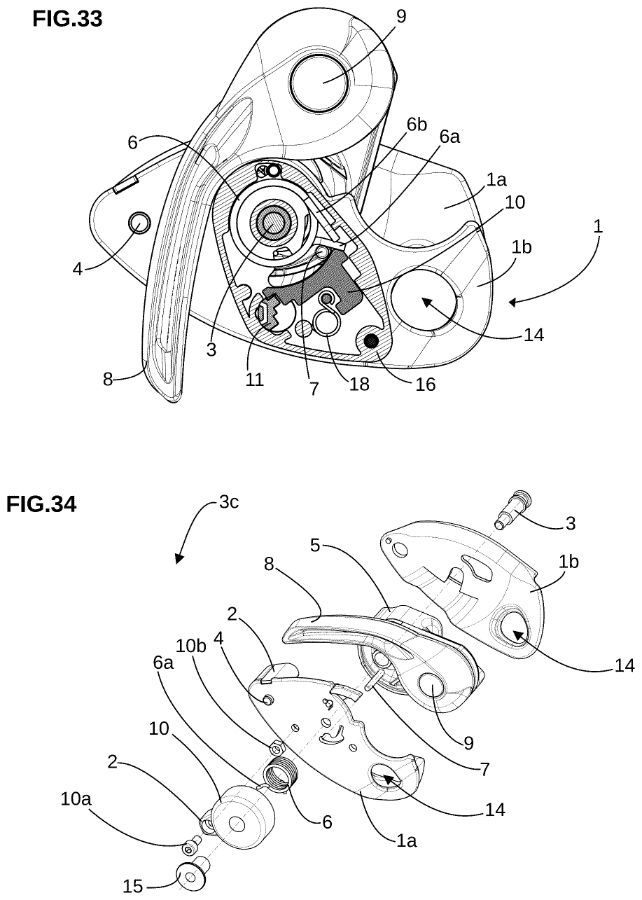

In preferential manner illustrated in FIG. 33, in the clamping position, the control device 11 blocks the selector switch 10 in the unlocked position. The control device 11 can be installed movable with any type of movement, for example in translation or swivelling. The control device 11 can be installed movable in a plane perpendicular to the pivot axis of the locking cam 5 with respect to the body 1 or with a component in the longitudinal direction of pivot axis of the locking cam 5 with respect to the body 1. In the illustrated embodiment, the control device 11 is installed swivelling around a pivot axis parallel to the pivot axis of the locking cam 5, but another movement is possible.

Advantageously, the first spring 6 is a torsion spring and more preferentially it is passed through by the first pivot shaft 3. Actuation of the first spring 6 by the locking cam 5 is facilitated and it is easier to activate and deactivate the first spring 6 by means of the selector switch 10. Such an embodiment is illustrated in FIGS. 1 to 40. The use of a torsion spring also makes for a better control of stresses when swivelling takes place.

In the embodiment illustrated in FIGS. 34 to 40, the selector switch 10 is installed swivelling around the first pivot shaft 3. The selector switch 10 has an obstacle 12. In the actuation position, the obstacle 12 of the selector switch 10 is arranged pressing against the first end 6a of spring 6 at a distance from the second end 6b of spring 6. Swivelling of the locking cam 5 in the first swivelling direction deforms the first spring 6. In the locked position, the obstacle 12 of the selector switch 10 is arranged pressing against the second end 6b of spring 6 at a distance from the first end 6a of the first spring 6.

This embodiment is particularly advantageous. In the actuation position, the first spring 6 biases the locking cam 5 in the second swivelling direction, i.e. in the direction of the stop, i.e. so as to reduce the distance between the stop 2 and the locking cam 5. The first spring 6 tends to clamp the rope A that is located between the stop 2 and the locking cam 5. This configuration is particularly suitable for belaying a lead climber. In the unlocked position, the first spring 6 biases the locking cam 5 in the second swivelling direction. The first spring 6 tends to facilitate sliding of the rope A that is located between the stop 2 and the locking cam 5 by moving the locking cam 5 to the third clamping position, for the purpose of increasing the distance between the stop 2 and the locking cam 5. This configuration is particularly suitable for belaying a climber who is belayed via the top of the route. The same the first spring 6 applies two opposite stresses on the locking cam 5 depending on whether the selector switch 10 is in the unlocked position or in the actuation position.

A similar operation can be obtained with the embodiments illustrated in FIGS. 1 to 33 by using a second spring 13 having a first end that is attached to the body 1 and a second end attached to the locking cam 5. The second spring 13 presents an opposite operation to the first spring 6. Whereas the first spring 6 presents a position of least stress when the locking cam 5 is in the first position, the second spring 13 presents a position of least stress when the locking cam 5 is in the third position. The second spring 13 applies a stress that tends to move the locking cam 5 from the second position or the third position to the first position. The second spring 13 applies a stress that tends to move the locking cam 5 from the first position to the third position. The stiffness of the second spring 13 is lower than the stiffness of the first spring 6. When the selector switch 10 is in the actuation position, the first spring 6 therefore tends to move the locking cam 5 to the first position, opposing the forces applied by the second spring 13.

In the unlocked position, the first spring 6 is deactivated, i.e. it no longer applies a stress on the locking cam 5 to move the locking cam 5 to the first position. Only the second spring 13 applies a stress on the locking cam 5 which tends to block the locking cam 5 in the third position in the absence of any outside stressing.

It is advantageous for the second spring 13 to be a torsion spring that is passed through by the first pivot shaft 3.

In the illustrated embodiments, the two flanges 1a and 1b each define a hole 14 designed for installation of an openable connector, preferably a carabiner. Once the carabiner has been installed in the two holes, the clamping device cannot be opened thereby preventing installation or removal of a strand of the rope A.

In preferential manner, the first pivot shaft 3 is fixed to the body 1 by means of a nut 15. For example, the first pivot shaft 3 passes through the cover 16 and the nut 15 presses the cover 16 against the body 1. The cover 16 can be fixed to the body 1 by means of a second bolt 17.

In one embodiment, a selector switch spring 18 is attached on the one hand to the selector switch 10 and on the other hand to the body 1. The selector switch spring 18 is preferentially installed so that the position of least stress is the actuation position. The embodiments illustrated in FIGS. 12 to 33 represent an implementation of the selector switch spring 18 for a selector switch 10 that moves in translation or by swivelling.

1. Rope clamping device comprising:
a body having a stop;
a first pivot shaft fixed to the body;
a locking cam installed swivelling around the first pivot shaft, the locking cam being installed movable with respect to the stop between a first position and a second position, the second position being farther from the stop than the first position;
a first spring having a first end and a second end, one of the first end and the second end being operatively connected to the locking cam by a first support and the other of the first end and the second end being operatively connected to the body by a second support;
a handle installed movable with respect to the body and fixed to the locking cam;
a selector switch fixed to the body and installed movable with respect to the body between an unlocked position and an actuation position;
wherein when the selector switch is in the actuation position, the first end is operatively connected to the locking cam by a first mechanical connection represented by abutment or attachment of the first end with the locking cam and the second end is operatively connected to the body by a second mechanical connection represented by abutment or attachment of the second end with the body, swivelling the locking cam modifying a deformation of the first spring, the first spring opposing swivelling the locking cam in a direction corresponding to moving the locking cam away from the stop;
wherein when the selector switch is in the unlocked position, the selector switch locks the first spring in a deformed state corresponding to the locking cam in the third position or the selector switch interrupts the second mechanical connection so that the first spring pivots without deformation.

2. Rope clamping device according to claim 1 wherein when the selector switch is in the unlocked position and the locking cam is in the second position, the locking cam is not functionally connected to the first spring so that the locking cam moves independently from the first spring.

3. Rope clamping device according to claim 2 wherein the selector switch has an obstacle jamming the second end of the first spring at a distance from the locking cam.

4. Clamping device according to claim 3 wherein when the locking cam is in the first position, the second end of the first spring prevents movement of the selector switch from the actuation position to the unlocked position.

5. Clamping device according to claim 4 wherein when the locking cam is in the second position, the second end of the first spring prevents movement of the selector switch from the actuation position to the unlocked position.

6. Clamping device according to claim 5 wherein when the locking cam is in a third position, the second end of the first spring allows movement of the selector switch from the actuation position to the unlocked position, the third position being farther from the stop than the second position.

7. Clamping device according to claim 4 wherein when the locking cam is in the first position, the second end of the first spring prevents movement of the selector switch from the unlocked position to the actuation position and/or when the locking cam is in the second position, the second end of the first spring prevents movement of the selector switch from the unlocked position to the actuation position.

8. Clamping device according to claim 1 comprising a control device installed movable between a clamping position and a release position and wherein, in the clamping position, the control device blocks the selector switch in the actuation position.

9. Clamping device according to claim 1 wherein the first spring is a torsion spring passed through by the first pivot shaft.

10. Clamping device according to claim 9 wherein the selector switch is installed swivelling around the first pivot shaft, wherein, in the actuation position, a pin of the selector switch is arranged pressing against the first end of the first spring at a distance from the second end of the first spring, and wherein, in the locked position, the pin of the selector switch is arranged pressing against the second end of the first spring at a distance from the first end of the first spring.

11. Clamping device according to claim 10, wherein when the selector switch is in the actuation position and the locking cam is in the first position, the first end and the second end define an angle of less than 90° and the pin of the selector switch is arranged between the first end and the second end, in the surface defined by the angle.

12. Clamping device according to claim 1 comprising a second spring having a first end fixed to the locking cam and a second end fixed to the body, the second spring applying a force opposing swivelling of the first spring from the third position to the first position, the second spring having a lower stiffness than a stiffness of the first spring.

13. Rope clamping device comprising:
a body having a stop;
a first pivot shaft fixed to the body;
a locking cam installed swivelling around the first pivot shaft, the locking cam being installed movable with respect to the stop between a first position and a second position, the second position being farther from the stop than the first position;
a first spring having a first end and a second end, one of the first end and the second end being operatively connected to the locking cam by a first support and the other of the first end and the second end being operatively connected to the body by a second support;
a handle installed movable with respect to the body and fixed to the locking cam;
a selector switch fixed to the body and installed movable with respect to the body between an unlocked position and an actuation position;
wherein when the selector switch is in the actuation position, the first end is operatively connected to the locking cam by a first mechanical connection represented by abutment or attachment of the first end with the locking cam and the second end is operatively connected to the body by a second mechanical connection represented by abutment or attachment of the second end with the body, swivelling the locking cam modifying a deformation of the first spring, the first spring opposing swivelling the locking cam in a direction corresponding to moving the locking cam away from the stop;
wherein when the selector switch is in the unlocked position, the first end is operatively connected to the body by a first mechanical connection represented by abutment or attachment of the first end with the body and the second end is operatively connected to the locking cam by a second mechanical connection represented by abutment or attachment of the second end with the locking cam, the first end bearing on the selector switch in the actuating position and the second end bearing on the selector switch in the unlocked position, the first spring opposing swivelling of the locking cam in a direction corresponding to the locking cam approaching the stop

14. Method for using a rope clamping device comprising the following steps:
providing a clamping device according to claim 1;
inserting a rope in the clamping device;
moving a selector switch between an unlocked position and an actuation position.
